(19) United States
(12) Patent Application Publication
(10) Pub. No.: US 2006/0206808 A1
(43) Pub. Date: Sep. 14, 2006

(54) System, method, and computer program product for transformation of markup-language objects

(75) Inventors: Siva R. Jasthi, White Bear Lake, MN (US); Venkata N. Marrapu, Blaine, MN (US)

Correspondence Address: DOCKET CLERK, PO BOX 800889, DALLAS, TX, 75380, US

(73) Assignee: UGS Corp., Plano, TX (US)

(21) Appl. No.: 11/075,397

(22) Filed: Mar. 8, 2005

(51) Int. Cl. G06F 17/00

(52) U.S. Cl. 715/522; 715/530; 715/513

(57) ABSTRACT

A system, method, and computer program product for transformation of markup-language objects which rely on the in the data patterns present in the input XML objects and the relationships between these objects is outlined in this invention. Such pattern-based interpretation and transformation of the input XML objects is achieved through the use of “Generic Style Sheets”.

### TECHNICAL FIELD OF THE INVENTION

The present invention is directed, in general, to information processing and transformation.

### BACKGROUND OF THE INVENTION

Conversion of data and objects from one format to another is a very common problem, and one for which many different solutions have been attempted.

In particular, several attempts have been made to automating the transformation of a given structured document (source XML) to another structured document (target XML). Extensible Markup Language (XML) is a simplified subset of the Standard Generalized Markup Language (SGML), capable of describing many different kinds of data. Its primary purpose is to facilitate the sharing of structured text and information across the Internet. Known transformation approaches are generally based on the input XML DTD (Document Type Definition) and output XML DTD, and on the specification of transformation rules that map these two DTDs. These approaches include developing tools that rely on input DTD, output DTD and transformation rules to transform an input XML to output XML.

DTDs define legal building blocks of XML and serve as a validation point to verify the correctness of XML. However, DTDs do not contain enough information to determine the structural relationships between the domain-specific objects. That is still the responsibility of XML parsing programs or custom style sheets.

One serious limitation of the custom Style Sheets is the costs involved in authoring (and subsequent maintenance) of the Style Sheets for each type of input data. For example, assume that a software solution ships 50 reports out of the box. The data required to generate the report is represented in XML. If it is required to produce HTML and Excel outputs from the XML, then a custom style sheet approach involves writing 50 * 2=100 Style Sheets (number of reports * output types=number of custom style sheets), which is a significant burden.

Commercial tools can produce very rich-looking outputs in numerous output formats. However, such tools which use proprietary technologies are expensive to buy and are not easy to integrate with native applications.

There is, therefore, a need in the art for a system, process, and computer program product for improved data and object conversion.

### SUMMARY OF THE INVENTION

A preferred embodiment provides a system, method, and computer program product for transformation of markup-language objects, and in particular, a system, method, and computer program product for pattern-based transformation of XML Objects.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIGS. 2 and 3 illustrate exemplary relationships between objects;

FIG. 4 depicts a flowchart of a process in accordance with a preferred embodiment;

FIGS. 5A-5I illustrate various cases of patterns that can exist in input XML; and

FIG. 6 depicts a flowchart in accordance with a preferred embodiment.

### DETAILED DESCRIPTION OF THE INVENTION

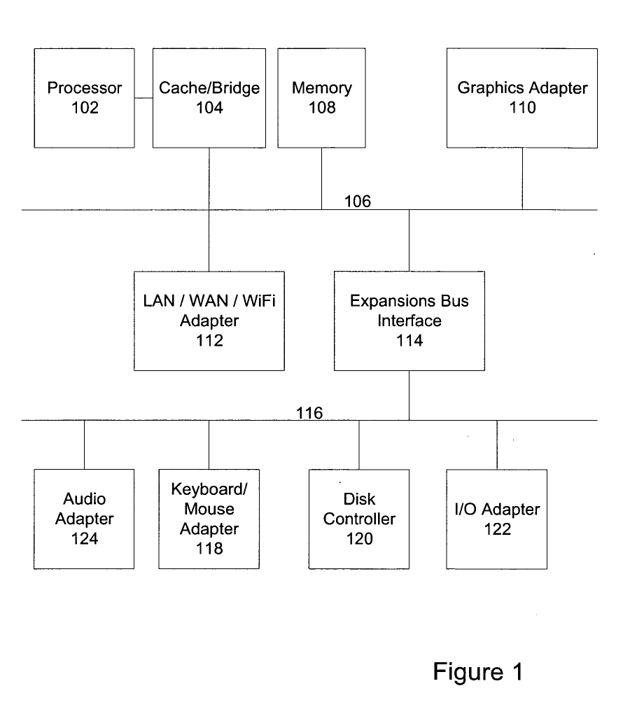

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

The embodiments described herein include a system, method, and computer program product to transform the object data that exists in an XML (or other markup language) format to other formats (such as HTML or spreadsheet) through the use of Generic Style Sheets. Generic Style Sheets rely on the patterns that exist in the input XML and carry out the transformations to produce presentations in human-readable format.

Note that in a preferred implementation, the spreadsheet format is one compatible with the widely used MICROSOFT EXCEL spreadsheet program, known to those of skill in the art. Of course, the teachings herein apply as well to other similar programs.

As used herein, “objects” are tangible or visible entities that are comprised of attributes and methods. A “Class” is a generic representation of a number of similar Objects. For example, “Car” is a class while “sedan”, “coupe”, etc. are objects of the type “Car”.

In any industry, the domain knowledge can be modeled in terms of (a) the domain-specific objects (b) how these objects are related to each other and (c) how the objects communicate with each other.

A combination of attributes and methods completely describes a Class/Object. For the purposes of describing the claimed inventions, it suffices to focus on the attributes of the Classes/Objects.

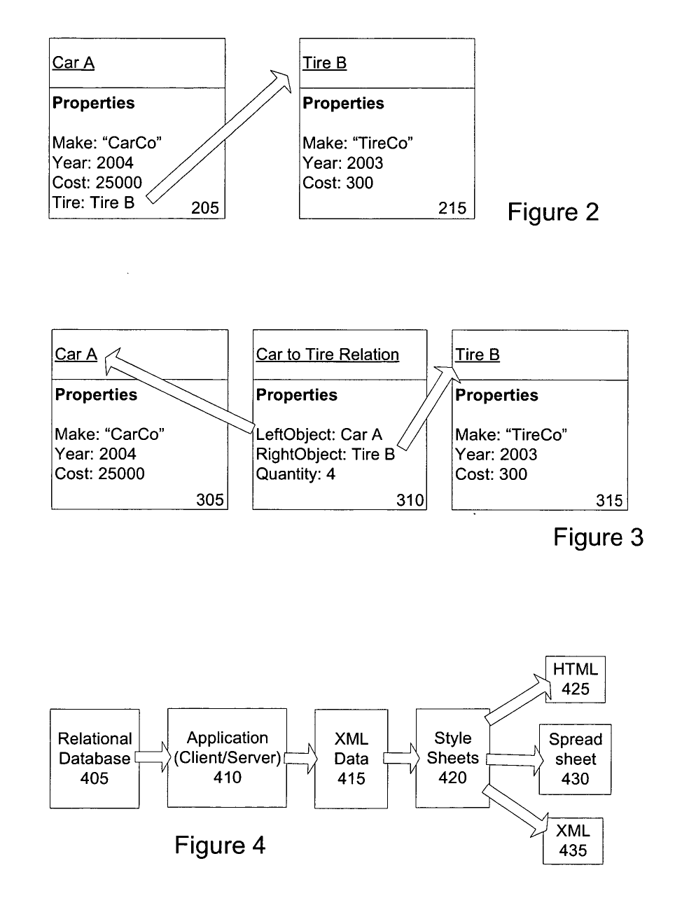

When objects in a domain are represented as Object Oriented (00) model, it is required to relate the objects to one another. There are two basic ways in which two objects can be related to each other, as illustrated in FIGS. 2 and 3.

The first way of relating objects is through the attribute. That is, an object B can be represented as an attribute of another object A. For example, a “Car” object 205 can have an attribute called “Tire,” which points to the tire object 215, as shown in FIG. 2.

The second way of relating objects is through another object. That is, an object P can also be related to another object Q through an intermediate relationship object called R. For example, a “Car” object 305 and a “Tire” object 315 can be related through a relationship object 310 called “Car to Tire”, as shown in FIG. 3.

XML (extensible Markup Language) is used to represent any kind of structured information in a neutral format, as are other markup languages. Such representation helps in encapsulating the data so that it can be passed between different systems.

XSLT (XSL Transformations) is a style sheet language for transforming XML documents into other XML documents. Style Sheets are XSLT documents that take an input XML and transform it to an output format.

Style Sheets can transform the data from a source XML structure (a) to another XML structure or (b) to human readable formats such as Text or HTML.

The input XML given to the Style Sheets can be generated from many sources. Some sources in getting input XML are given below.

First, the XML may be coming from an external system for consumption by the users or the internal system.

Next, the XML can be generated through custom methods where a programmer specifies what data need to be extracted from the system.

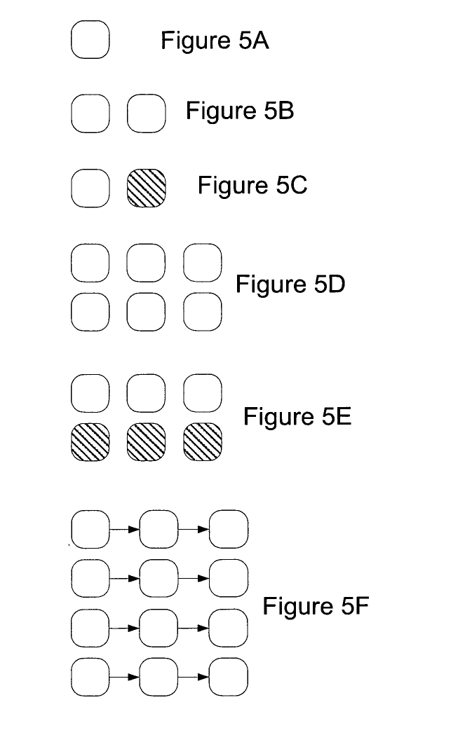

Also, the XML may be generated making use of the “report definitions” where an end-user specifies what data need to be extracted from the system. This scenario is common when the systems enable the users to define the reports or data-export, as illustrated in the flowchart of FIG. 4. Here, the client or server application 410 reads from the database 405. The XML data 415 from the database is processed using style sheets 420. Finally, the desired file is produced, typically as HTML 425, a spreadsheet file 430, or an XML file 435. It is to be noted that the output formats are not limited to just these three formats (HTML, spreadsheet, XML). The output can be other formats such as “Portable Document Format” (PDF), a word processing format such as MICROSOFT WORD, and others.

Various embodiments of the current invention are illustrated in the context of the third use case. In many applications, reporting is a common theme. Users generate reports to know the status of objects in the system. The data in the system may exist in relational databases (such as Oracle, SQL). And the data retrieved from these databases is extracted to XML (a) for easier representation of the data in a neutral format and (b) for representation of the same XML data in multiple output formats such as HTML or Spreadsheet.

In such scenario, the disclosed embodiments provide a Style Sheet to transform the data into human readable format such as Html or Plain Text or Spreadsheet data. Typically the sequence of steps for generating a report will include—(1) users define report; (2) users generate the report which involve; (2.a) retrieving the data from the database; (2.b) representing the information in XML; (2.c) applying a Style Sheet to the input XML; (2.d) generating the report in html or spreadsheet; (3) users view the report; and (4) repeat steps 1 to 3 until they get the report right.

The current technique of solving the above problem involves the usage of “Custom Style Sheets” (in Step 2.c) where there is a 1-to-1 mapping between the input XML and the output format.

Applying “Custom Style Sheets” in step (2.c) has the following limitations: (a) It is expensive to write custom Style Sheets for each and every definition of the report (b) Customers and end users are usually good at defining the report. However, these users are not experts in writing the Style Sheets (c) The errors in the “Report Definition” are not known until one writes a custom stylesheet and views the data.

The preferred embodiments include a system, method, and computer program product to overcome these limitations through the user of “Generic Style Sheets” that rely on the patterns or characteristics present in the input XML data.

According to these embodiments, in general: (1) Any domain information can be modeled in terms of Objects.

(2) These Objects are related to each other as shown, for example, in FIGS. 2 and/or FIG. 3.

(3) Such Object collection can be represented in XML.

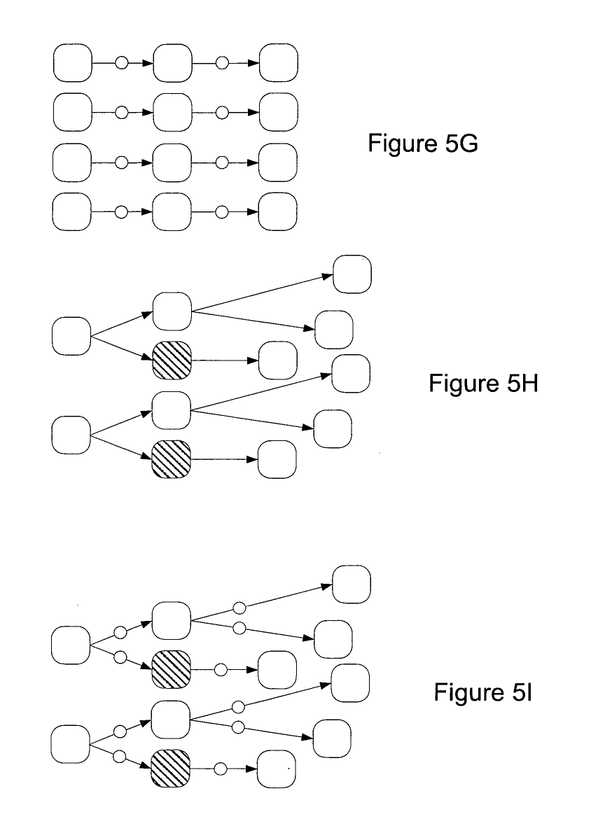

(4) The patterns that exist in the input XML can be determined by parsing the XML. Some patterns that can exist in the input XML are illustrated in FIGS. 5A-5I.

(5) Different data patterns warrant different presentation patterns.

(6) “Generic Style Sheets” identify these patterns in the input XML and render the data accordingly thus alleviating the need to write a “Custom Style Sheet”

The “Generic Style Sheet” approach of the disclosed embodiment offers one or more of the following benefits, and others, in comparison to the conventional “Custom Style Sheet” approach.

(1) It is not required to author a Custom Style Sheet whenever the user defines a Report.

(2) For each output format (spreadsheet, html), one Generic Style Sheet is good enough. Users only need to select the output format. It is not required to select the Style Sheet.

(3) Given the output format, a Generic Style Sheet provides the most suitable presentation based on the mapping between the data patterns and presentation patterns, as illustrated in FIGS. 5A-5I, and described more fully below.

(4) End users can express what they want (define a report) and dictate what output they want (html or spreadsheet), but they need not know what data is coming out of the database and how it should be structured.

(5) End users focus on the report definition rather than in writing the style sheets.

(6) Any errors committed in the report definition phase are immediately visualized in user-familiar output format so that corrective action can be taken.

There are several different cases of mappings between object patterns in the input XML and the corresponding presentation templates, as follows:

Case 1—The input XML pattern includes no item pattern. No objects exist in the input XML file (input XML file is empty). In this case, the outline of presentation template includes a page showing an informative message, such as “No data to report.”

Case 2—The input XML pattern includes one item pattern (only one item object), as illustrated in FIG. 5A. In this case, the outline of presentation template includes a simple table showing attribute-value pairs.

Case 3—The input XML pattern includes two similar items, where two item objects of the same type (homogeneous) exist in the input XML, as illustrated in FIG. 5B. In this case, the outline of presentation template includes a simple table showing attribute-value-value.

Case 4—The input XML pattern includes two different items, where two item objects of the different type (heterogeneous) exist in the input XML, as illustrated in FIG. 5C. In this case, the outline of presentation template includes a simple table showing attribute—value of object 1—value of object 2. If any attribute is not applicable to an object, that cell is shown with a “-”.

Case 5—The input XML pattern includes many (more than two) objects of the same type, as illustrated in FIG. 5D. In this case, the outline of presentation template includes a single table, much like a spreadsheet, where column represent attributes and each row represents an object.

Case 6—The input XML pattern includes many (more than two) objects of different types, as illustrated in FIG. 5E. In this case, the outline of presentation template includes a table, much like a spreadsheet, where column represent attributes and each row represents an object, and for each object, a separate table is displayed.

Case 7—The input XML pattern includes a simple unified object pattern, as illustrated in FIG. 5F, where items are related to other items. Relations do not have any attributes. Only one relationship is coming from each object, and users visualize the information as a single logical object. In this case, the outline of presentation template includes a simple table showing attribute—value of object 1—value of object 2. If any attribute is not applicable to an object, that cell is shown with a—Each row in the spreadsheet represents information about two or more objects that are related to each other.

Case 8—The input XML pattern includes a complex unified object pattern, as illustrated in FIG. 5G, where items are related to other items, and the relations also have attributes specified (indicated by the circles on the arrows). Only one relationship is coming from each object, and users visualize the information as a single logical object. In this case, the outline of presentation template includes a simple table showing attribute - value of object 1—value of object 2. If any attribute is not applicable to an object, that cell is shown with a “-”. Each row in the spreadsheet represents information about two or more objects that are related to each other, and also contains the information about the relationship attributes between each pair of objects.

Case 9—The input XML pattern includes simple tree pattern, as illustrated in FIG. 5H. Relations do not have any attributes. Many relationships are coming from each object. In this case, the outline of presentation template includes an indented tree structure. Such tree structure gives a visual representation of how the objects are related.

Case 10—The input XML pattern includes complex tree pattern, as illustrated in FIG. 5I, where relations also have attributes specified. Many relationships are coming from each object. In this case, the outline of presentation template includes an indented tree structure, and the tree structure also shows the information about relationship attributes. Such tree structure gives a visual representation of how the objects are related.

Note that those of skill in the art will recognize that there can be variations to the patterns described above. One variation is asymmetrical data—in each of the above patterns, the data can be asymmetrical. For example, the input data has two parts, but only one of these parts has a supplier.

Another variation is unequal attribute sizes, where the number of attributes defined on an object is different. For example, if the input XML contains two objects, a “problem report” and “change request,” the number of attributes on these two objects can be different.

Another variation is in navigation depth. For example, the pattern in FIG. 5F has shown only 3-level-deep navigation. However, the input data may contain navigations much longer than that. For example, a navigation that spans multiple level might be: object “user”→relationship “creates”→object “problem report”→relationship “is implemented by”→object “change request”→relationship “impacts”→object “part”→relationship “is describe by”→object “document”.

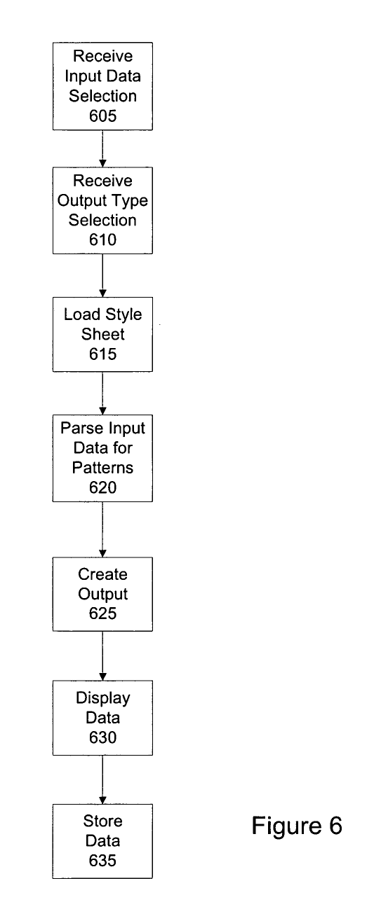

FIG. 6 depicts a flowchart of a process in accordance with a preferred embodiment. First, the system receives a selection of input data from a user (step 605). Preferably, this includes the identification of an input XML file. Alternately, another file format, including a database format and others, can be loaded and converted to an XML input data.

Next, the system receives the user's selection of output types (step 610). In the preferred embodiment, this will be in HTML format, a spreadsheet format, or an xml format.

Next, the system loads a generic style sheet corresponding to the selected output type (step 615). The system parses the input data to recognize data patterns, as described herein (step 620). The system then creates an output according to the input data and recognized data pattern, using a presentation template in the generic style sheet, as described above (step 625). The output is then optionally displayed to the user (step 630), and/or stored in file corresponding to the selected output type (step 635).

In at least some embodiments, the user is able to select the output format (i.e. html or spreadsheet). It is not required for the user to select a style sheet sample because the specifics as to how the objects exist in the input XML may not be known to the end user. That responsibility is taken over by the “Generic Style sheet.”

Also, in some embodiments, the number of XSL documents stored is limited; i.e., one XSL document for one output format. One of these Generic Style Sheets is chosen by the user based on the output he/she desired. In various embodiments, the appropriate transformation and presentation are handled by the Generic Style sheet, and the Generic Style sheet depends on the object patterns present in the input XML in its completeness rather than on some particular elements.

The characteristics or patterns in context are coming from the input XML, in a preferred embodiment.

Various embodiments provide that the output need not be limited to just XML. The output format or presentation scheme can be HTML or spreadsheet format. Each output format preferably uses one Generic Style Sheet. The Generic Style Sheet identifies the data patterns that exist in input XML and maps these patterns to the suitable presentation format. Such identification of patterns is based on the input data, not a DTD.

One known tool, MICROSOFT INTERNET EXPLORER, provides that, when an XML document is opened, the browser uses a built-in generic Style Sheet to render the XML document. It is good in visualizing the raw XML data in its lowest possible semantics without any relation to the domain information.

However, the user's view of the domain is at a higher level than raw XML data. The preferred embodiments, by contrast, include objects and the relationships between objects that are present in the input XML, and produce the output depicting such relationships.

Another known tool, PRETTY XML TREE VIEWER, produces an HTML document that shows, in the form of ‘ASCII art’, the node structure of an XML document. A CSS I style sheet (tree-view.css) helps render the HTML in an appealing style.

However, this method fails in recognizing the higher level abstractions as seen by the end-users in terms of objects and relationships. Instead, its focus is mainly in representing the low-level XML nodes. Some disclosed embodiments, by contrast, include objects and the relationships between objects that are present in the input XML, and produces the output depicting such relationships.

Other background information, and other approaches to similar issues, can be found in United States Patents and published patent applications U.S. Pat. Nos. 6,463,440, 20010011287, 20020107913, and 20030084405, all of which are hereby incorporated by reference.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method performing a data conversion, comprising:
loading a style sheet;
parsing an input data to determine data patterns; and
creating an output data, corresponding to the input data, according to the data patterns and the style sheet.

2. The method of claim 1, further comprising receiving a selection of an output type, wherein the output data is formatted according to the output type.

3. The method of claim 1, further comprising a selection of an input data.

4. The method of claim 1, wherein the input data is in XML form.

5. The method of claim 1, further comprising displaying and storing the output data.

6. The method of claim 1, wherein the data patterns include at least one object.

7. The method of claim 1, wherein the data patterns include relationships between at least two objects.

8. The method of claim 1, wherein the data patterns include at least one object and at least one corresponding object attribute.

9. The method of claim 2, wherein the output type is selected from the group comprising HTML format and spreadsheet format.

10. The method of claim 1, wherein the style sheet is a generic style sheet, and wherein the output data provides a generic transformation of the input data according to the data patterns.

11. A computer program product tangibly embodied in a machine-readable medium, comprising:
instructions for loading a style sheet in a data processing system;
instructions for parsing an input data to determine data patterns; and
instructions for creating an output data, corresponding to the input data, according to the data patterns and the style sheet.

12. The computer program product of claim 11, further comprising instructions for receiving a selection of an output type, wherein the output data is formatted according to the output type.

13. The computer program product of claim 11, further comprising instructions for receiving a selection of an input data.

14. The computer program product of claim 11, wherein the input data is in XML form.

15. The computer program product of claim 11, further comprising instructions for displaying and storing the output data.

16. The computer program product of claim 11, wherein the data patterns include at least one object.

17. The computer program product of claim 11, wherein the data patterns include relationships between at least two objects.

18. The computer program product of claim 11, wherein the data patterns include at least one object and at least one corresponding object attribute.

19. The computer program product of claim 12, wherein the output type is selected from the group comprising HTML format and spreadsheet format.

20. The computer program product of claim 11, wherein the style sheet is a generic style sheet, and wherein the output data provides a generic transformation of the input data according to the data patterns.
